(19) United States
(12) Patent Application Publication
(10) Pub. No.: US 2005/0267814 A1
(43) Pub. Date: Dec. 1, 2005

(54) Method and apparatus for resale order processing of point of sale data

(75) Inventors: Venkiteswaran V. Balakrishnan, Nurani Palakkad (IN); Sreeram Pranatharthiharan, Bangalore (IN); Gokula Sundar, Trichy (IN)

Correspondence Address: KENYON & KENYON, 1500 K STREET NW, SUITE 700, WASHINGTON, DC, 20005, US

(73) Assignee: SAP Aktiengesellschaft

(21) Appl. No.: 10/855,514

(22) Filed: May 28, 2004

(51) Int. Cl. G06F 17/60

(52) U.S. Cl. 705/26

(57) ABSTRACT

Embodiments of the present invention provide improved methods of and apparatus for providing resale order processing of externally generated point-of-sale data. In accordance with an embodiment of the present invention, a resale order infrastructure including a resale order object layer implementing a multi-layer programming model approach including a user interface layer to display data, an object layer implemented as an application programming interface layer to include processing and business logic, an interaction layer to manage data flow between the user interface layer and the object layer, and a database layer to control database interactions. The resale order infrastructure also includes a business infrastructure to execute the business logic associated with data in the resale order object layer; and a business rule engine connected to the business infrastructure to execute business rules based on the data in the business infrastructure.

### FIELD OF THE INVENTION

The field of the invention relates to processing point-of-sale data and, in particular to methods of and apparatus' for providing resale order processing of externally generated point-of-sale data.

### BACKGROUND

In just about every industry there is a need to capture generic sales information, for example, capturing at a distributor point-of-sale (“POS”) data from a variety of different retailers who sell the distributor's products. This POS data needs to be captured and processed for downstream processing by the distributor as well as manufacturers of the products. This downstream processing can include calculating price protection payments, standard inventory reporting, and replenishment planning. Since the data is obtained from external customer computer systems, i.e., retailer systems, the distributor must be able to deal with multiple customer part numbers being associated with each single item in the distributor's inventory. Likewise, the distributor may have individual part and customer numbers being associated with different part and customer numbers, respectively, from a variety of the distributor's suppliers, i.e., manufacturers.

Currently the POS data sent by different customers to a supplier is used for different purposes like reporting, payment of claims, etc. In addition, the data that is send by each of the customers invariably have inconsistencies between each customer as well as inconsistensies within a single customer's own data. As a result any data received needs to be cleaned and subjected to further processing like reporting, payment of claims, etc. The challenge of this scenario includes:
converting external customer data so it is compatible with internal data formats;
performing consistency checking for the data, often at different levels, depending on which customer is reporting the information; and
defining/configuring what further processing needs to be carried out by the system.

Unfortunately, current customer relationship management systems do not provide the capability for a distributor to efficiently and effectively receive, clean and process data in multiple formats. For example, existing systems, such as, CRM Generic Order provided by SAP, do not handle external data and do not have a process control capability to support processing scenarios. Therefore, it would useful to streamline the process and minimize the difficulties associated with providing consistent order processing of inconsistent POS data from divergent sources.

### BRIEF DESCRIPTION OF THE DRAWINGS

FIG. 1 is a block diagram of a resale order framework for receiving, cleaning and processing external data from multiple sources, in accordance with an embodiment of the present invention.

FIG. 2 is a flow diagram of a method of operation in the resale order framework of FIG. 1, in accordance with an embodiment of the present invention.

FIG. 3 is a data-model diagram of a resale order data-model for use in the resale order framework of FIG. 1, in accordance with an embodiment of the present invention.

FIG. 4 is a data-model diagram of a new application customized using the resale order framework (i.e., create an order data-model) for use in the resale order framework of FIG. 1, in accordance with an embodiment of the present invention.

FIG. 5 is a screen shot of a user interface selection screen for the entry of resale order data, in accordance with an embodiment of the present invention.

FIG. 6 is a screen shot of a user interface work area screen for the resale order data received in the user interface selection screen in FIG. 5, in accordance with an embodiment of the present invention.

FIG. 7A is a screen shot of a business framework data determination screen for the resale order data, in accordance with an embodiment of the present invention.

FIG. 7B is another screen shot of a business framework data determination screen for the resale order data, in accordance with an embodiment of the present invention.

FIG. 8 is a screen shot showing a part of the logic in a data determination handler, in accordance with an embodiment of the present invention.

FIG. 9A is a screen shot of a business framework business logic handler screen used to define the business logic handler, in accordance with an embodiment of the present invention.

FIG. 9B is another screen shot of a business framework business logic handler screen used to define the business logic handler, in accordance with an embodiment of the present invention.

FIG. 10 is a screen shot showing a part of the logic in a business logic/processing handler, in accordance with an embodiment of the present invention.

FIG. 11A is a screen shot of a business engine rule definition screen used to define business rules, in accordance with an embodiment of the present invention.

FIG. 11B is a screen shot of a business engine rule set definition screen used to define business rule sets, in accordance with an embodiment of the present invention.

FIG. 12 is a screen shot showing a part of the logic in a rule implementation to validate end customer information, in accordance with an embodiment of the present invention.

FIG. 13 is a screen shot of a schema definition screen used to assign business rules and rule sets to the schema, in accordance with an embodiment of the present invention.

FIG. 14A is a screen shot of a schema system step definition screen used to customize the schema, in accordance with an embodiment of the present invention.

FIG. 14B is a screen shot of a schema access definition screen used to customize the schema, in accordance with an embodiment of the present invention.

FIG. 15A is a screen shot of another schema determination screen used to assign system steps in a schema to an application, in accordance with an embodiment of the present invention.

FIG. 15B is a screen shot of another schema determination screen used to define schema determination attributes, in accordance with an embodiment of the present invention.

FIG. 16 is a screen shot of a schema attributes screen used to maintain attributes associated with the schema, in accordance with an embodiment of the present invention.

FIG. 17 is a detailed block diagram of the business rule engine that illustrates how a schema is determined in a transaction, in accordance with an embodiment of the present invention.

FIG. 18 is a block diagram of a resale tracking application illustrating an overall process in the resale tracking application, in accordance with an embodiment of the present invention.

FIG. 19 is a flow diagram of an alternative method of operation in the resale order framework of FIG. 1, in accordance with an embodiment of the present invention.

### DETAILED DESCRIPTION

Embodiments of the present invention provide improved methods of and apparatuses for providing a flexible infrastructure, for example, a flexible framework to receive (capture) and process point-of-sale (“POS”) data in different formats and levels of completeness. In general, an infrastructure, (e.g., a framework) may be implemented as a standard, generic software architecture on which components of multiple applications may be implemented to provide cross-application compatibility. The POS data may be received from external sources; however, embodiments of the present invention are contemplated in which internally generated POS data may be used. For example, in a system in accordance with an embodiment of the present invention, POS data may be received from several different sources in different formats and may be captured in a resale order framework (infrastructure). In the present embodiment, the data may be received in an electronic data interchange (“EDI”) format message or an extensible markup language (“XML”) format message. The framework may include an order document with multiple fields to capture data, for example, customer (partner), product, date, quantity, price, etc. data from each customer. The order document may use its own user interface (“UI”) and a mechanism to implement a variety of data checking processes and processing logic on the received data.

In accordance with an embodiment of the present invention, the framework may be used for any scenario, for example, a price protection scenario to capture and clean incoming data, for example, XML messages, for downstream processing. For example, in a shipping scenario, a distributor may sell products to special end customers at a previously agreed to contract price. As a result, when the distributor sells the products at the lower price to the special end customers from the distributor's normally procured, the distributor may claim the price difference between the price the distributor paid for each product and at what price the distributor is selling to the special end customers. Similarly, the distributor may report the sales information back to the manufacturer in either EDI or XML formatted messages and the manufacturer may capture the data contained in the sales information for validation and to aid in, for example, production and replenishment planning.

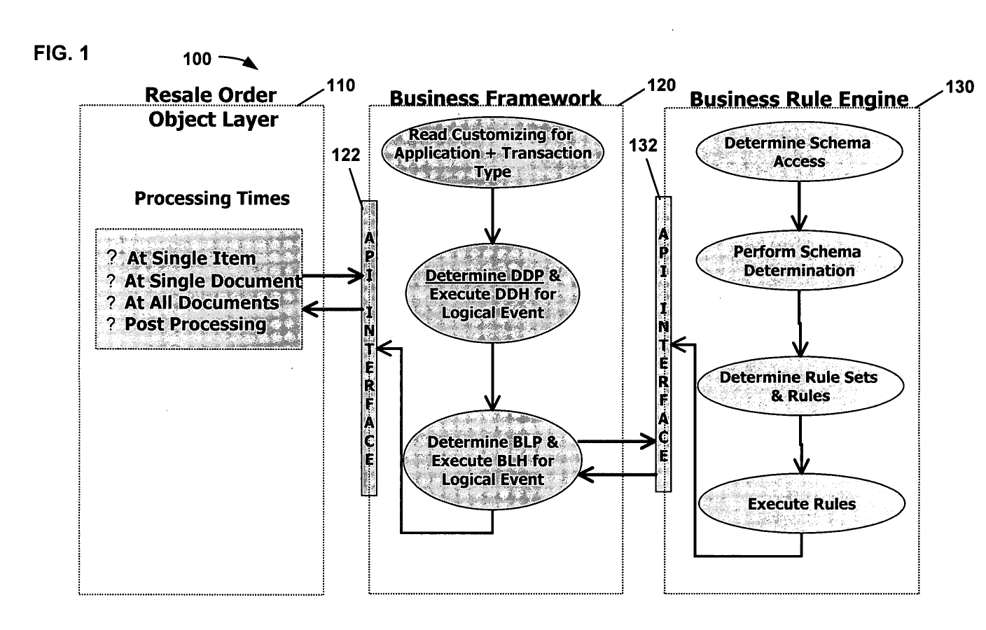

FIG. 1 is a block diagram of a resale order framework for receiving, cleaning and processing external data from multiple sources, in accordance with an embodiment of the present invention. In FIG. 1, a resale order framework 100 may include a resale order object layer 110 that may be connected to a business framework 120, which may be connected to a business rule engine 130. Resale order object layer 110 may include a resale order object that may act as a container for the incoming external data. The resale order object may have a flexible data model and be application independent. This may enable the resale order object to receive any type of external data (i.e., any data received from a source system external to resale order framework 100 including, for example, a customer and/or distributor system, and in multiple possible formats). For example, the resale order object may use a generic UI that may be defined by individual applications and may enable event-driven business logic. The business logic may be configured for each application and may use an encapsulated/layered programming approach to provide application independent services.

In accordance with an embodiment of the present invention, the resale order object may provide several generic services including, for example, providing: a standard data model, support for a standardized UI that works for both web-enabled as well as regular applications and support for data extraction into a main database; invoking business framework 120 to enable plugging in business logic at predefined processing points; and providing a data persistency mechanism, a search mechanism and message handling. However, to be able to use the generic services provided by the resale order object, a business scenario may register with the framework by creating applications and transactions for the scenario. To aid in this registration, the resale order object may provide a customizing service that enables an application to define its own data model, interfaces, UI, etc. Although the design of the resale order data-model may have been driven by the need to capture externally reported data; internal data may also be used. The resale order data-model is a generic data model and, in general, does not contain any application specific extensions. Each application that uses the resale order data-model may define its own “specific” data model using standard framework customizing.

In accordance with an embodiment of the present invention, a programming model for the resale order framework data-model may include a multi-layer approach, for example: 1) a UI layer, 2) an interaction layer (“IL”), 3) an object layer (“OL”), and 4) a database (“DB”) layer. The UI layer may deal with the visualization and display of data to include, for example, enabling and disabling of fields in the UI based on information/check results from the OL. The IL may act as a bridge between the OL, that is, the business layer, and the UI layer. The OL, which may be an API layer that encapsulates/includes the processing and business logic. The DB layer may take care of database interactions. Advantageously, this programming model approach may make the migration from classic UIs to web-enable UIs much easier. Likewise, this programming model approach advantageously makes the business/processing logic a part of the API layer, which may lead to a more consistent way of executing business checks/processing.

In accordance with an embodiment of the present invention, in FIG. 1, processing of the received data may occur in resale order object layer 110 and execution of business logic associated with the data may occur in business framework 120. For example, processing of the received data may include checking, validation and formatting of the received data to be compatible for further processing within resale order object layer 110. The execution of the business logic may be initiated from resale order object layer 110 at different times during the processing of the data. For example, the business logic may be initiated in resale order object layer 110 at the end of processing of a single data item, at the end of processing of a single document (i.e., one instance of a resale order document), at the end of processing of all documents (i.e., all resale order document instances), and after processing has completed and the data has been saved.

In FIG. 1, in accordance with an embodiment of the present invention, when the business logic is initiated, information on an application, a transaction type, a logical event, and a processing time associated with the data may be provided to business framework 120 via a business framework application programming interface (“API”) interface 122. Business framework 120 may read customizing information for the application and transaction type associated with the data to prepare the data for further processing. Business framework 120 may execute a data determination handler (“DDH”), which enables determination of certain specific business data from the received data, for example, this may include, determining with which contract the data is associated, what the appropriate unit of measure “(UOM”) is for the product represented by the data, determining new price information and performing claim calculations. In accordance with an embodiment of the present invention, each DDH may be implemented as a business add-in (“BAdl”), which may allow the customer to supply custom business logic for the data item associated with the BAdl. Each DDH may be linked to a specific application and/or transaction type via a data determination profile “(DDP”). The DDP may define the sequence and/or order of the data determination and which DDHs are to be executed for the application and/or transaction type and the logical event. As a result, additional data and other determination logic may be added to the application at each of the application, transaction type and logical event levels.

In FIG. 1, in accordance with an embodiment of the present invention, business framework 120 may execute a business logic handler “(BLH”) associated with the logical event. The BLH may be used to implement business logic that is associated with an application and/or transaction type via a business logic profile (“BLP”). This business logic may include, for example, performing business checks (i.e., checking whether the reported contract is a valid contract, or checking whether the requested claim amount matches the calculated claim amount); re-routing internal documents; creating a credit memo request; updating a central database with the processed data; performing a channel inventory update; and updating earned sales commissions information. In accordance with an embodiment of the present invention, each BLH may also be implemented as a BAdl, which may allow the customer to supply additional business logic on an application, transaction type and/or logical event basis. Each BLH may be linked to a specific application and/or transaction type via a business logic profile “(BLP”). The BLP may define the sequence and/or order of execution and which BLHs need to be executed for the application and/or transaction type and the logical event. As a result, additional processing logic may be added to the application at each of the application, transaction type and logical event levels.

In FIG. 1, in accordance with an embodiment of the present invention, an executing application's BLH may request business rule engine 130, via a business rule engine API interface 132, to execute one or more business rules that may exist between business partners that are exchanging the data. The business rules in business rule engine 130 may specify the basis for the relationship between the business partners. For example, some typical business rule implementation scenarios may include, for example, resale validations, claim validations, duplicate record checking, price protection eligibility, matching of claims with charge backs, automatic approval of contracts, and automatic approval of design registration requests. The business rules may be implemented as schemas and each schema may include one or more rule sets, where each rule set may include one or more rule identifications and their associated rule implementations. The schemas may include customized and/or default schemas that may be called by an application from business framework 120 that provides system step and application data to business rule engine 130. Business rule engine 130 may determine a schema access and perform a schema determination by, for example, querying a determination table with the application data to locate a schema for the application. The schema may include a customized schema or a default schema, if a customized schema has not been created and associated with the specific application data passed from business framework 120. Business rule engine 130 may determine one or more rule sets and rules associated with the located schema and may execute the determined rules. Business rule engine 130 may provide a result set back to the calling BLH in business framework 120 via business rule engine API interface 132. The calling BLH may provide the result set to resale order object layer 110 via business framework API interface 122 and resale order object layer 110 may update the central database with the result set and may send messages to the sources of the information as well as to the distributor's the manufacturing partners who supply the products.

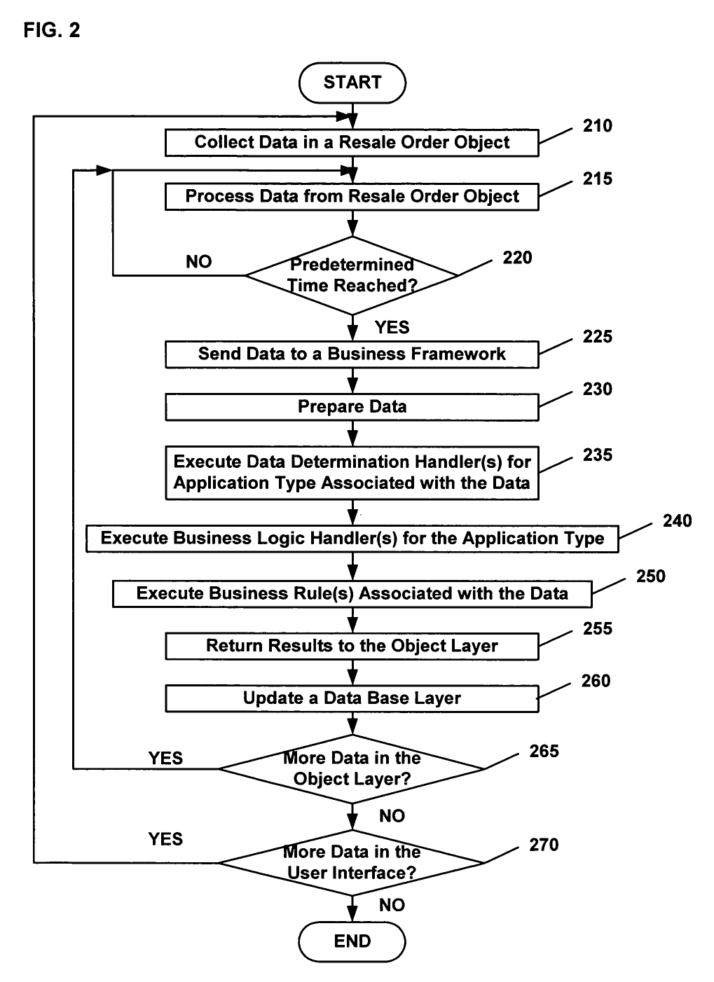

FIG. 2 is a flow diagram of a method of operation in a data model of the resale order framework of FIG. 1, in accordance with an embodiment of the present invention. In FIG. 2, data may be collected (210) in a resale order object in resale order framework 100. Data in the resale order object may be processed (215) in resale order object layer 110. For example, the processing (215) may include checking, validation and formatting of the received data for further processing within resale order object layer 110. The data may be processed (215) in resale order object layer 110 until a predetermined processing time and/or event may be determined (220) to have occurred. If the predetermined processing time and/or event has not been determined (220) to have occurred, the method may loop back to process (215) additional data in the resale order object and continue processing from that point as previously described.

In FIG. 2, if the predetermined processing time and/or event has been determined (220) to have occurred, the data may be sent (225) to business framework 120 via business framework API interface 122 for further processing. In addition to the data, the application information, the transaction type, the logical event and the processing time may be sent to business framework 120. The data may be prepared (230) for application of the business logic in business framework 110 by, for example, by determining/selecting a DDP associated with the data, and DDHs associated with the application type DDP for the data may be executed (235) in business framework 120. The method may determine/select a BLP associated with the data and execute (240) BLHs associated with the application type in business framework 120. Business rules associated with the data may be determined/selected and executed (250) by business rule engine 130, which may return (255) results of the execution, for example, a result set, to resale order object layer 110 via the BLH that sent (245) the data to business rule engine 130. The method may update (260) a database layer (not shown) from resale order object layer 110. Whether resale order object layer 110 may contain more data may be determined (265) and, if more data is determined (265) to be contained in resale order object layer 110, the method may loop back and process (215) data from another resale order object and continue processing from there as described above. Alternatively, if more data is determined (265) not to be contained in resale order object layer 110, the method may determine (270) whether there may be additional data in the user interface and, if additional data is determined (270) to be in the user interface, loop back and collect (210) the additional data into the resale order object in resale order object layer 110 and continue processing from there as described above. Alternatively, if additional data is not determined (270) to be in the user interface, the method may terminate.

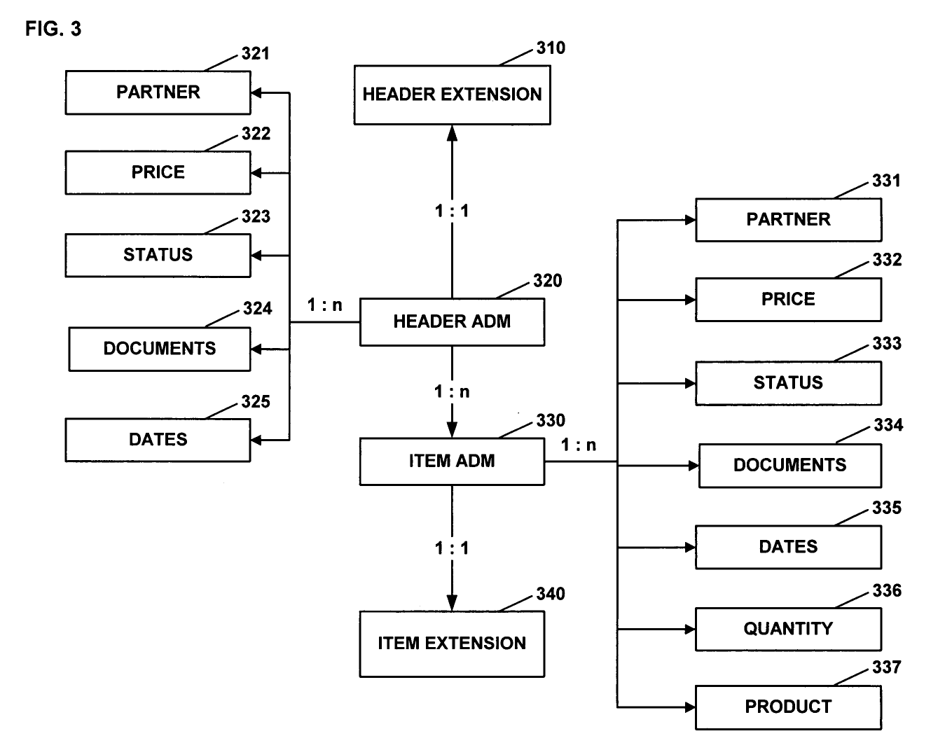

FIG. 3 is a data-model diagram of a generic order data-model for use with any scenario in the resale order framework of FIG. 1, in accordance with an embodiment of the present invention. In FIG. 3, the data model for a resale order object may include a single header extension 310, which may be used to identify the business partner that is associated with the resale order object and header extension 310 may be linked to a single header administrative record 320. Header administrative record 320 may contain information on the object, for example, who created the object, the object's number, who updated the object last, etc. Header administrative record 320 may also be linked to one or more item administrative records 330 and the one or more item administrative records 330 may each be linked to a single, separate item extension block 340.

In FIG. 3, in accordance with the present embodiment of the invention, header administrative record 320 may be linked to one or more (i.e., 1:n, where n=the number of occurrences of each field) of each of the following fields a partner field 321, a price field 322, a status field 323, a documents field 324, and a dates field 325. Partner field 321 may include identification information for the business partner. Price field 322 may include, for example, a net price, a net price less a discount amount, etc. Status field 323 may include, for example, status information related to the order, such as, is the order approved, in review, etc. Documents field 324 may include, for example, information on related documents, such as, contract numbers under which the product(s) are being purchased. Dates field 325 may include, for example, relevant product billing dates, shipping dates and receipt dates.

In FIG. 3, in accordance with the present embodiment of the invention, each item administrative record associated with header administrative record 320 may be linked to one or more (i.e., 1:n, where n=the number of occurrences of each field) of each of the following fields a partner field 331, a price field 332, a status field 333, a documents field 334, and a dates field 335. Partner field 331 may include identification information for the business partner. Price field 332 may include, for example, a net price, a net price less a discount amount, etc. Status field 333 may include, for example, status information related to the order, such as, is the order approved, in review, etc. Documents field 334 may include, for example, information on related documents, such as, contract numbers under which the product(s) are being purchased. Dates field 335 may include, for example, relevant product billing dates, shipping dates and receipt dates. Quantity field 336 may include, for example, information on how many of the item identified by item administrative record 330 have been sold. Product field 337 may include, for example, information on the specific product, such as the product name, stock number, etc.

In FIG. 3, although the partner, price, status, documents and dates fields 321/331, 322/332, 323/333, 324/334, 325/335 linked to header administrative record 320 and item administrative record 330 are shown as separate, duplicate fields, it is contemplated that the fields may be implemented only once with links from both header administrative record 320 and item administrative record 330.

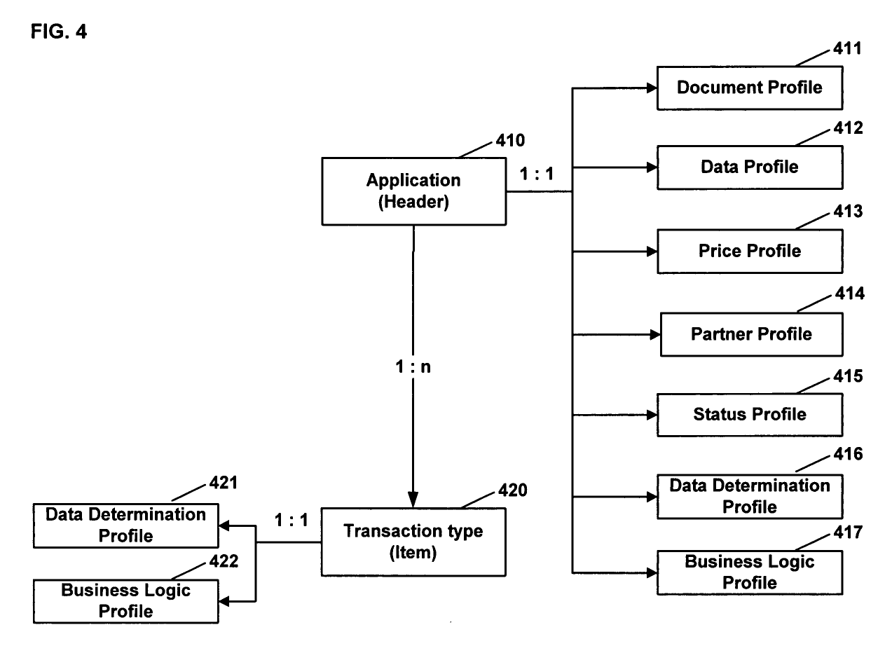

FIG. 4 is a data-model diagram of a new application customized using the resale order framework (i.e., create an order data-model) for use in the resale order framework of FIG. 1, in accordance with an embodiment of the present invention. In FIG. 4 an application (header) record 410 may be linked to one or more transaction type records 420. Application (header) record 410 may be linked to a document profile field 411, a data profile field 412, a price profile field 413, a partner profile field 414, a status profile field 415, a data determination profile field 416, and a business logic profile 417. Document profile field 411 may include, for example, profile information on the document containing the resale order data and data profile field 412 may include, for example, profile information on the type of data contained in the document. Price profile field 413 may include, for example, profile information on the price paid or to be paid for the product and a partner profile field 414 may include, for example, profile information (name, etc.) on the business partner from whom the document originated. Status profile field 415 may include, for example, profile information on the current status of the processing of the document (approved, in review, finished, etc.). Data determination profile field 416 may include, for example, profile information on the sequence/order of data determination and which data determination handlers are to be executed for the application. Business logic profile 417 may include, for example, profile information on the sequence/order of execution of the handlers and which business logic handlers are to be executed for the application.

In FIG. 4, each of the one or more transaction type records 420 may be linked to a data determination profile field 421, and a business logic profile 422. Data determination profile field 421 may include, for example, profile information on the sequence/order of data determination and which data determination handlers are to be executed for the transaction. Business logic profile 422 may include, for example, profile information on the sequence/order of execution of the handlers and which business logic handlers are to be executed for the transaction.

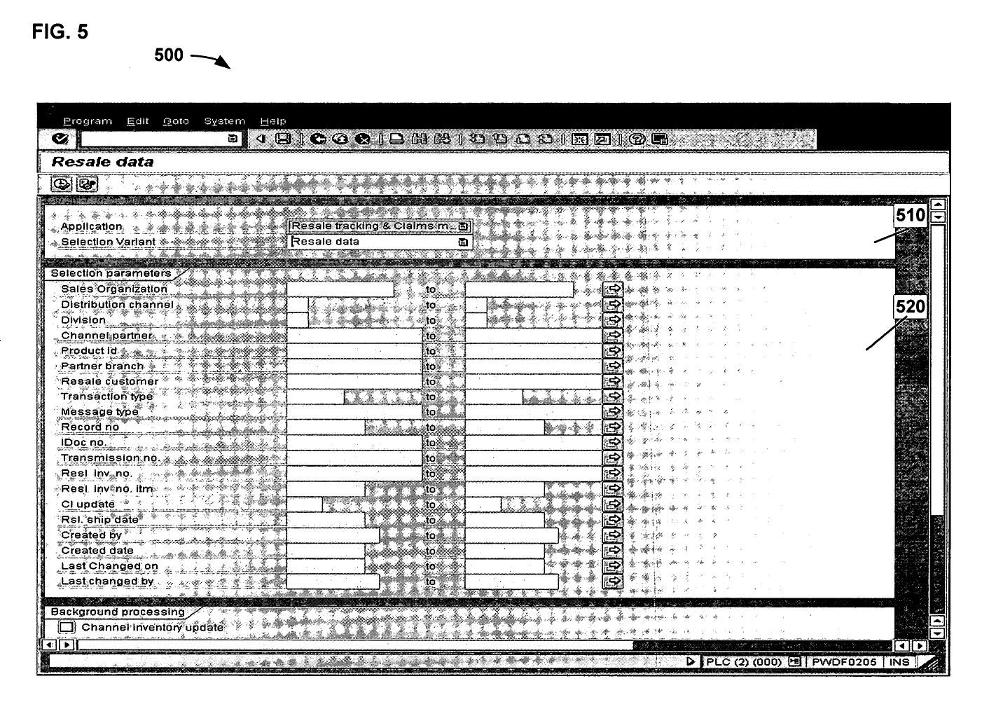

FIG. 5 is a screen shot of a user interface selection screen for the entry of resale order data, in accordance with an embodiment of the present invention. In FIG. 5, a user interface selection screen 500 may be customized to be application specific selection screens. In general, the user interface layer may be implemented to be separate from other layers in the data model to support both web-enabled user interfaces and standard application-specific graphical user interfaces (“GUIs”). In the embodiment in FIG. 5, in a first screen section 510, an active application may be seen to be identified as “Resale Tracking & claims Management” and using “Resale data.” In a second screen section 520, multiple selection parameters for the application may be seen to provide for the entry of range information for each parameter. However, in accordance with embodiments of the present invention, all or none of each of the multiple selection parameters range information may be entered.

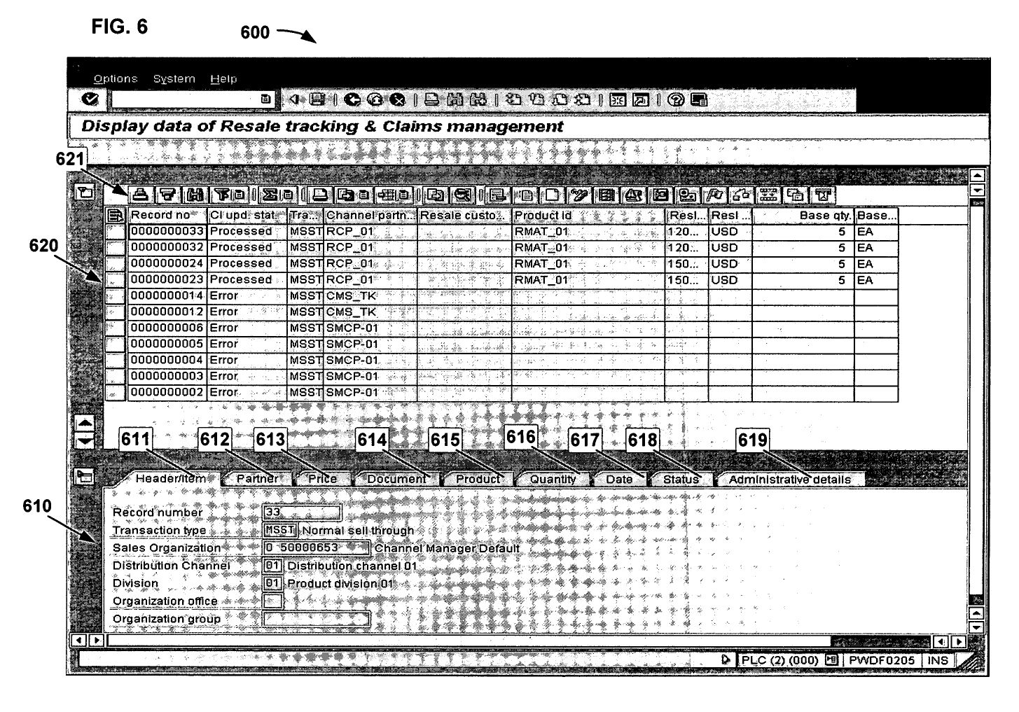

FIG. 6 is a screen shot of a user interface work area screen for the resale order data received in the user interface selection screen in FIG. 5, in accordance with an embodiment of the present invention. in FIG. 6, a user interface work area screen 600 may include a tab section 610, which may include a variety of tabs for each of the fields related to header record 320 and/or and item record 330 from FIG. 3, and an information display grid 620, which may be used to display the information associated with a currently selected tab in tab section 610. In FIG. 6, tab section 610 may include a header/item tab 611, a partner tab 612, a price tab 613, a document tab 614, a product tab 615, a quantity tab 616, a date tab 617, a status tab 618 and an administrative details tab 619. Each of the above tabs is directly related to the partner, price, document, product, quantity, date, status and administrative detail fields described in FIG. 3. As seen in FIG. 6, header/item tab 611 is selected and as a result, multiple fields of information associated with the header/item tab 611 may be displayed in information display grid 620. Information display grid 620 may also include a customizable application specific toolbar 621, which may be modified/enhanced as needed for each application.

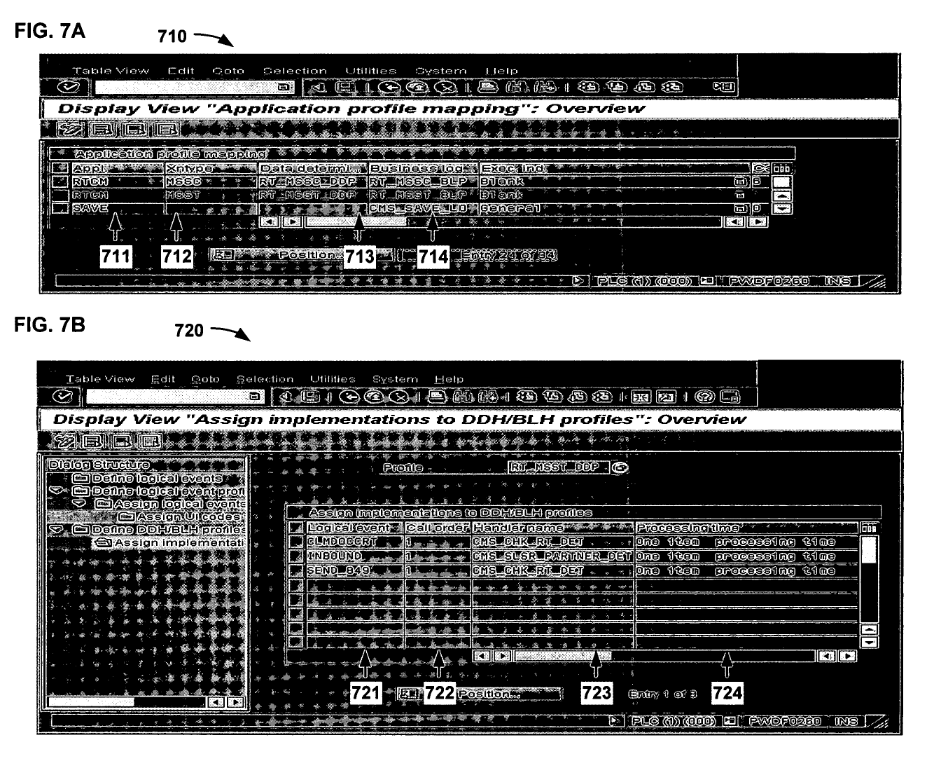

FIG. 7A is a screen shot of a business framework data determination screen for the resale order data, in accordance with an embodiment of the present invention. Specifically, FIG. 7A is a screen shot of a display view of an application profile mapping screen 700 having, but not limited to, an application column 711 and a transaction type column 712 that define a data determination profile, which may be named in a data determination profile column 713 may be defined. For example, in FIG. 7A, each row may provide details for a different data determination profile, which may be named in data determination profile column 713 and have a business logic profile column 714.

FIG. 7B is another screen shot of a business framework data determination screen for the resale order data, in accordance with an embodiment of the present invention. Specifically, FIG. 7B is a screen shot of a generic display view of an assign implementations to DDH/BLH profiles screen 720 having, but not limited to, a logical event column 721, a call order column 722, a handler name column 723 and a processing time column 724. For example, in the embodiment in FIG. 7B, each row may provide details for a different data determination handler.

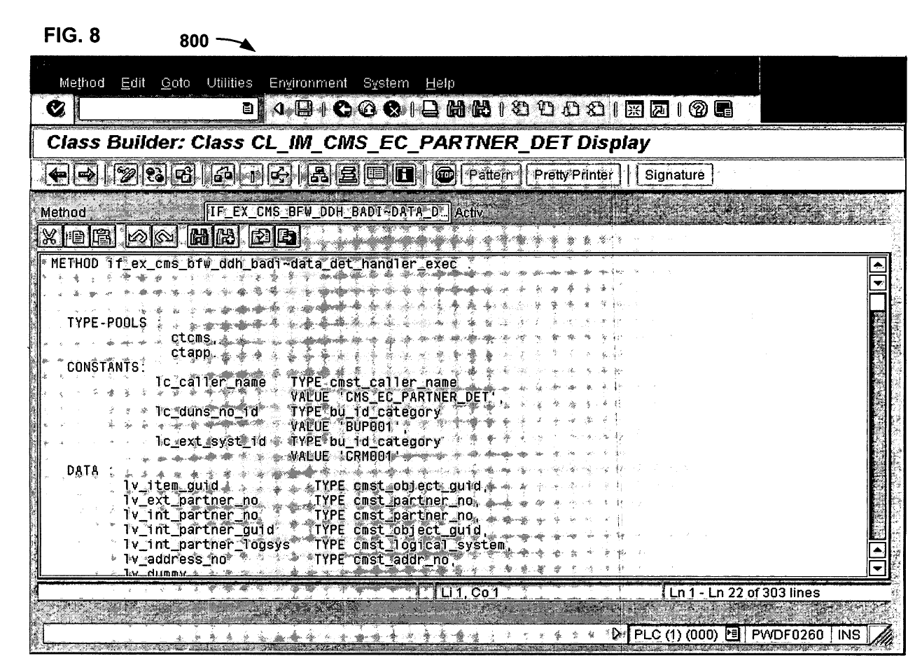

FIG. 8 is a screen shot showing a part of the logic in a data determination handler, in accordance with an embodiment of the present invention. In FIG. 8, a screen 800 shows a portion of a special logic coding section that is associated with a class builder that may determine an internal end customer from the reported data.

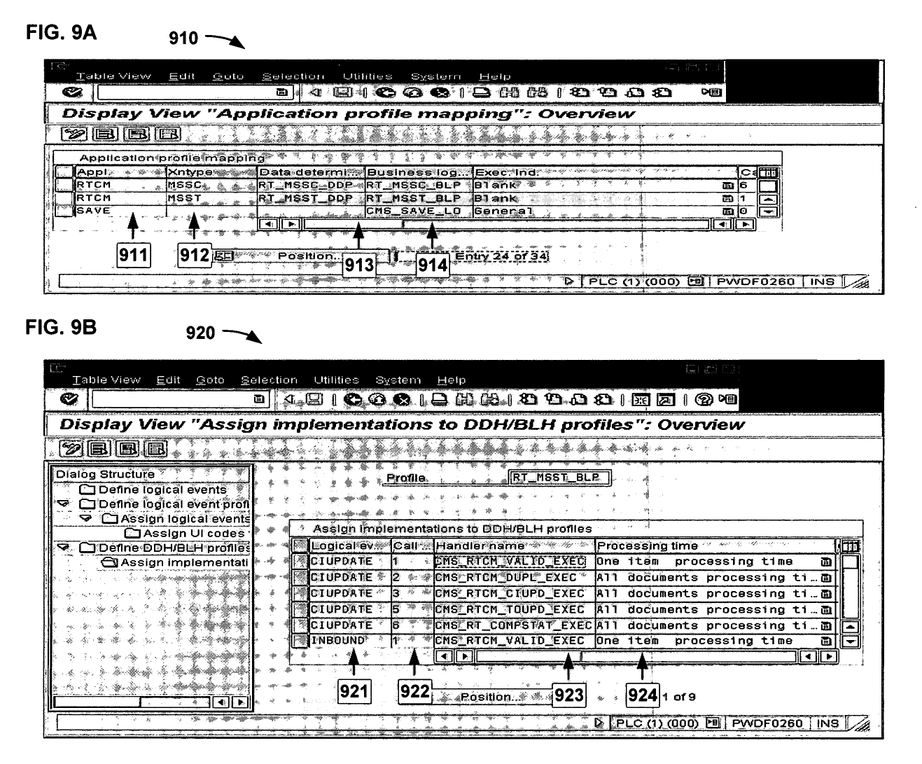

FIG. 9A is a screen shot of a business framework business logic handler screen used to define the business logic handler, in accordance with an embodiment of the present invention. Specifically, FIG. 9A is a screen shot of a display view of an application profile-mapping screen 900, similar to that shown in FIG. 7. Application profile mapping screen 900 may have, but is not limited to, application column 711 and transaction type column 712 that define a data determination profile, which may be named in data determination profile column 713 may be defined. For example, in FIG. 9A, each row may provide details for a different data determination profile, which may be named in business logic profile column 914.

FIG. 9B is another screen shot of a business framework business logic handler screen used to define the business logic handler, in accordance with an embodiment of the present invention. Specifically, FIG. 9B is a screen shot of a generic display view of an assign implementations to DDH/BLH profiles screen 920, similar to that shown in FIG. 7. In FIG. 9, assign implementations to DDH/BLH profiles screen 920 may have, but is not limited to, logical event column 721, call order column 722, handler name column 723 and processing time column 724. For example, in the embodiment in FIG. 7B, each row may provide details for a different business logic handler.

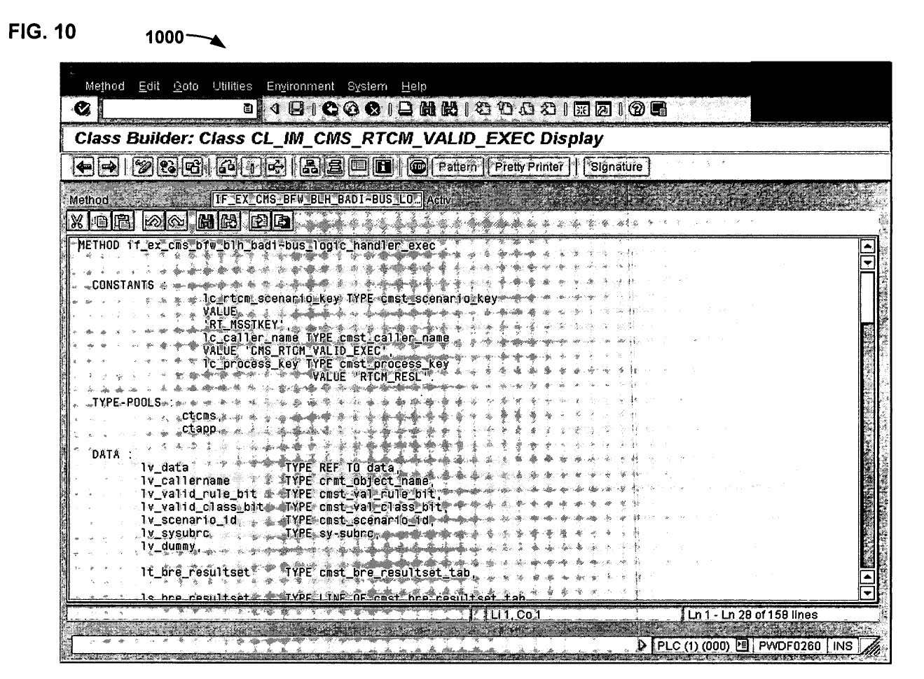

FIG. 10 is a screen shot showing a part of the logic in a business logic/processing handler, in accordance with an embodiment of the present invention. In FIG. 10, a screen 1000 shows a portion of a special logic coding section that is associated with a class builder that may invoke a business rule engine to validate Manufacturer Side Sell-Through Transaction (“MSST”) records.

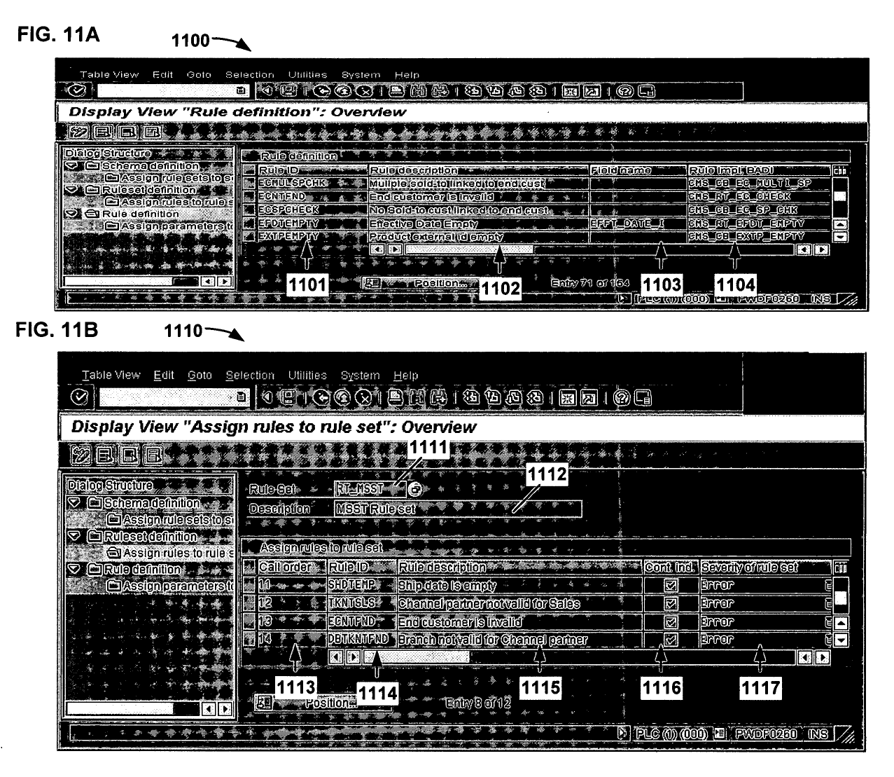

FIG. 11A is a screen shot of a business engine rule definition screen used to define business rules, in accordance with an embodiment of the present invention. in FIG. 11A, a rule definition screen 1100, which may be used to define business rules associated with each schema, may include a rule identification column 1101, a rule description column 1102, a field name column 1103 and a rule implementation BAdl column 1104. Rule identification column 1101 may be used to assign names for each of the business rules. Rule description column 1102 may be used to provide a description of the function of each business rule and field name column 1103 may be used to identify names of fields that may be used by each business rule listed in rule identification column 1101. A rule BAdl column 1104 may be used to associate the business rule with a name of a specific BAdl that implements the business rule.

FIG. 11B is a screen shot of a business engine rule set definition screen used to define business rule sets, in accordance with an embodiment of the present invention. In FIG. 11B, a rule set definition screen 1110, which may be used to define a business rule set with which one or more rules may be associated, may include a rule set name field 1111, a rule set description field 1112, a call order column 1113, a rule identification column 1114, a rule description column 1115, a continue indicator column 1116 and a severity of rule set column 1117. Rule set name field 1111 may be used to hold the name of the specific rule set being defined in rule set definition screen 1110. Rule set description field 1112 may be used to hold a description of the function of the rule set being defined. Call order column 1113 may be used to specify the order in which the rules listed in rule set definition screen 1110 are called to be executed. Rule identification column 1114 may be used to assign rule names from rule identification column 1101 column in FIG. 11A to the business rule set being defined in rule set definition screen 1110. Rule description column 1115 may be used to display the rule names originally associated with each rule identification in rule description column 1102 in FIG. 11A. Continue indicator column 1116 may be used to identify whether to process subsequent rules, for example, if the continue indicator is checked then, even if a rule fails, the subsequent rules may be processed, and if the continue indicator is unchecked then, if a rule fails, subsequent rules in the rule-set are may not be executed. Severity of rule set column 1117 may be used to describe whether the failure of a rule is a Warning, Fatal error, etc. Depending on the severity of the failure, applications may take appropriate steps to control the processing flow to ensure processing may continue or may terminate appropriately and without a system crash.

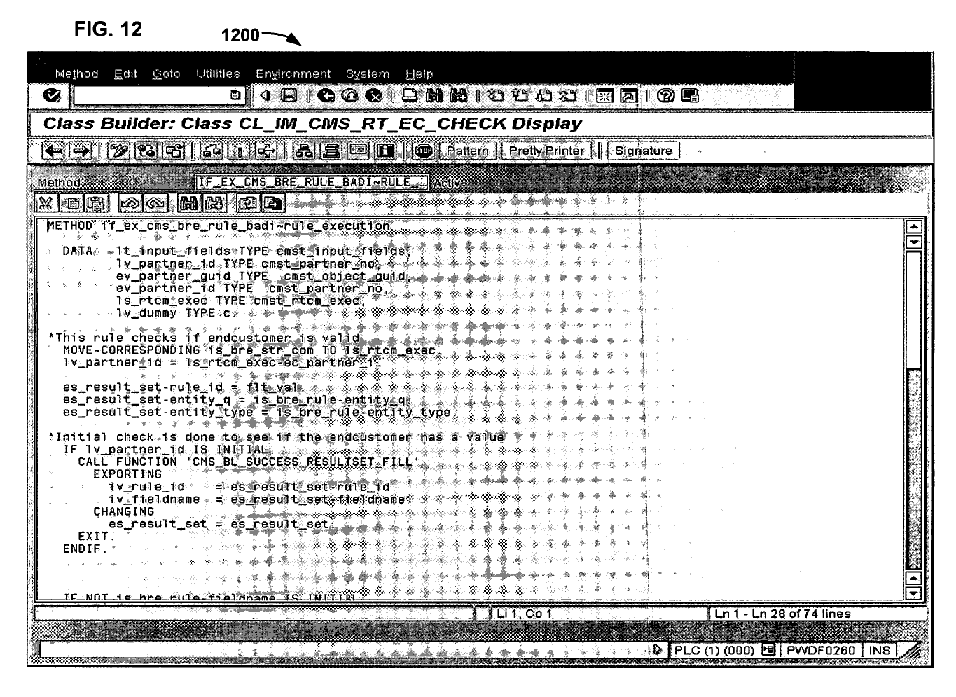

FIG. 12 is a screen shot showing a part of the logic in a rule implementation to validate end customer information, in accordance with an embodiment of the present invention. in FIG. 12, a screen 1200 shows a code portion of a business rule BAdl implementation that checks to determine whether the end customer is valid.

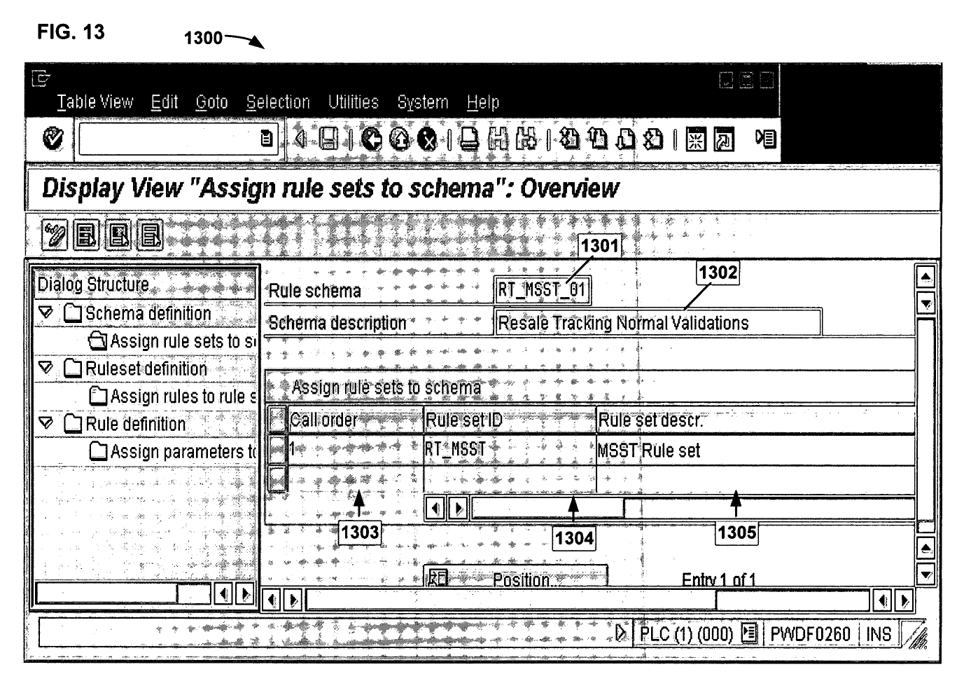

FIG. 13 is a screen shot of a schema definition screen used to assign business rules and rule sets to the schema, in accordance with an embodiment of the present invention. In FIG. 13, a schema definition screen 1300, which may be used to define which business rules and rule sets are associated with each schema, may include a rule schema name field 1301, a schema description field 1302, a call order column 1303, a rule set identification column 1304 and a rule set description column 1305. Rule schema name field 1301 may be used to assign a name to the schema being defined in schema definition screen 1300. Schema description field 1302 may be used to provide a description of the function of the schema. Call order column 1303 may be used to specify the order in which the rule sets listed in schema definition screen 1300 are called to be executed. Rule set identification column 1304 may be used to display the name of the rule set defined in rule set name field 1111 in FIG. 11B. Rule set description column 1305 may hold a description of the function of the rule set.

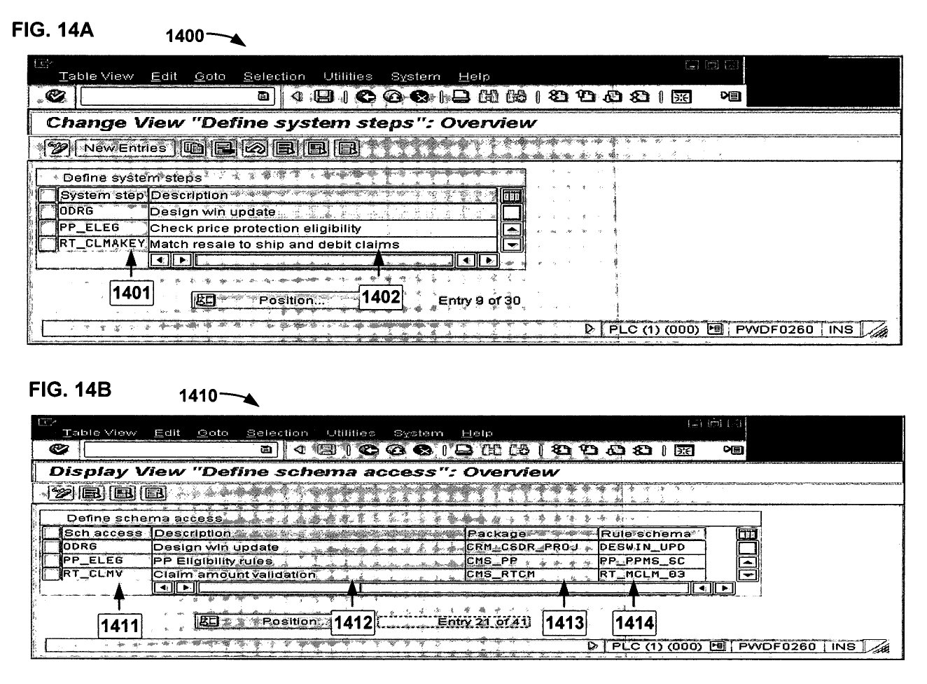

FIG. 14A is a screen shot of a schema system step definition screen used to customize the schema, in accordance with an embodiment of the present invention. In FIG. 14A, a schema system step definition screen 1400 may include a system step column 1401 and a system step description column 1402. System step column 1401 may be used to define the system steps to be included in the schema and system step description column 1402 may be used to provide a description for each system step listed in system step column 1401.

FIG. 14B is a screen shot of a schema access definition screen used to customize the schema, in accordance with an embodiment of the present invention. In FIG. 14B, a schema access definition screen 1410 may include a schema access column 1411, a schema description column 1412, a package column 1413 and a rule schema column 1414. Schema access column 1411 may be used to define from which system steps the schema may be accessed. Schema description column 1412 may be used to provide a description for each system step listed in schema access column 1411. Package column 1413 may be used to define the package where the generated program logic would reside, for example, as a part of the Business rule engine, there may be some code generation involved and the generated code may be stored under the package specified in package column 1413. Rule schema column 1414 may be used to list a default schema that is to be executed if a customized schema has not been created.

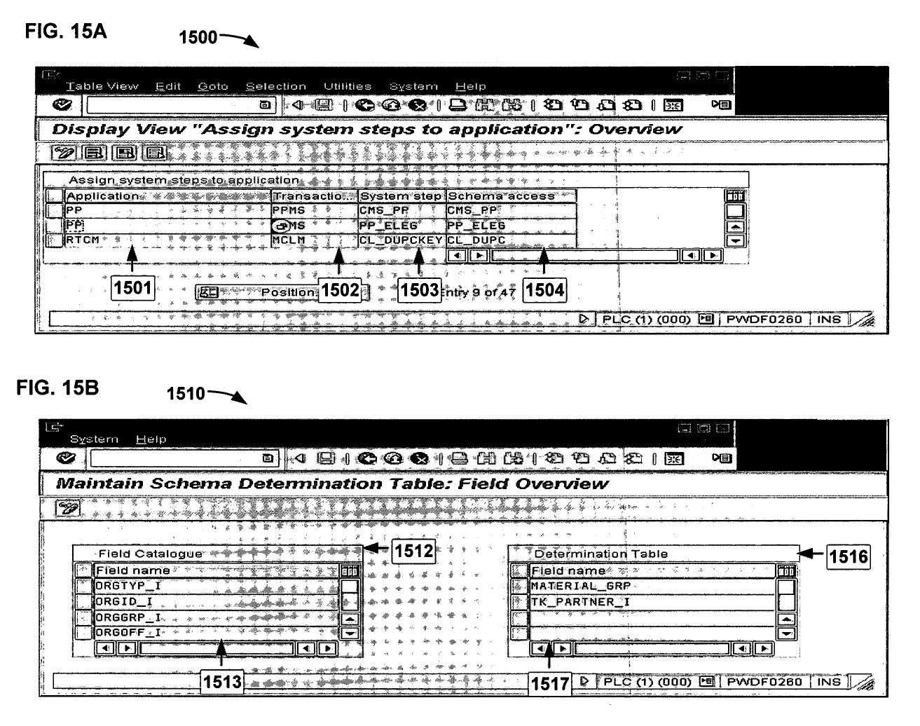

FIG. 15A is a screen shot of another schema determination screen used to assign system steps in a schema to an application, in accordance with an embodiment of the present invention. In FIG. 15A, a system step assignment screen 1400 may include an application column 1501, a transaction column 1502, a system step column 1503 and a schema access column 1504. Application column 1501 may be used to identify which applications are to be assigned to system steps. Transaction column 1502 may be used to identify the transaction associated with the application. System step column 1503 may be used to define which system step is associated with the application and schema access column 1504 may be used to define from which schema the system step in system step column 1503 may be called.

FIG. 15B is a screen shot of another schema determination screen used to define schema determination attributes, in accordance with an embodiment of the present invention. In FIG. 15B, a maintain schema determination screen 1510 may include a field catalogue table 1512, which may include a field name column 1513 to list the business attributes that may be used for the schema. Maintain schema determination screen 1510 may also include a determination table 1516, which may include a field name column 1517 to list schema determination attributes for a given scenario.

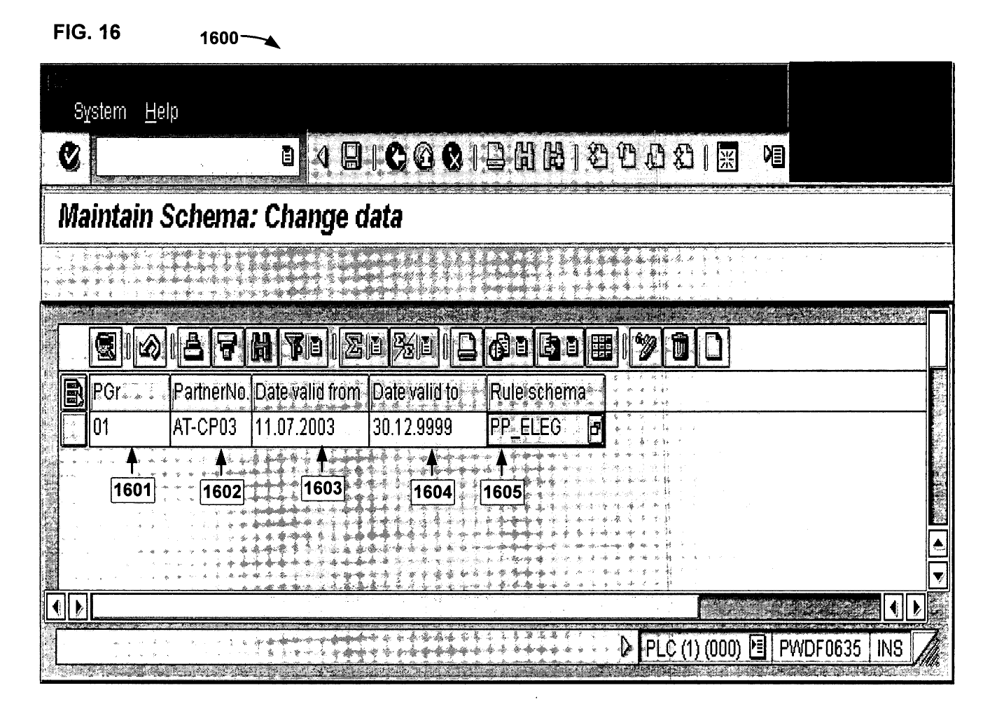

FIG. 16 is a screen shot of a schema attributes screen used to maintain attributes associated with the schema, in accordance with an embodiment of the present invention. In FIG. 16, a maintain schema determination attributes screen 1600 may include a Product Group (“PGr”) field 1601, a partner number field 1603 for the schema, a data valid from field 1603, a data valid to field 1604 and a rule schema field 1605. The PGr field 1601 and partner number field 1603 may be described to be attributes associate with the schema listed in schema field 1605. Data valid from field 1603 and data valid to field 1604 may be used to define a validity period, which may be used, for example, for seasonal promotions.

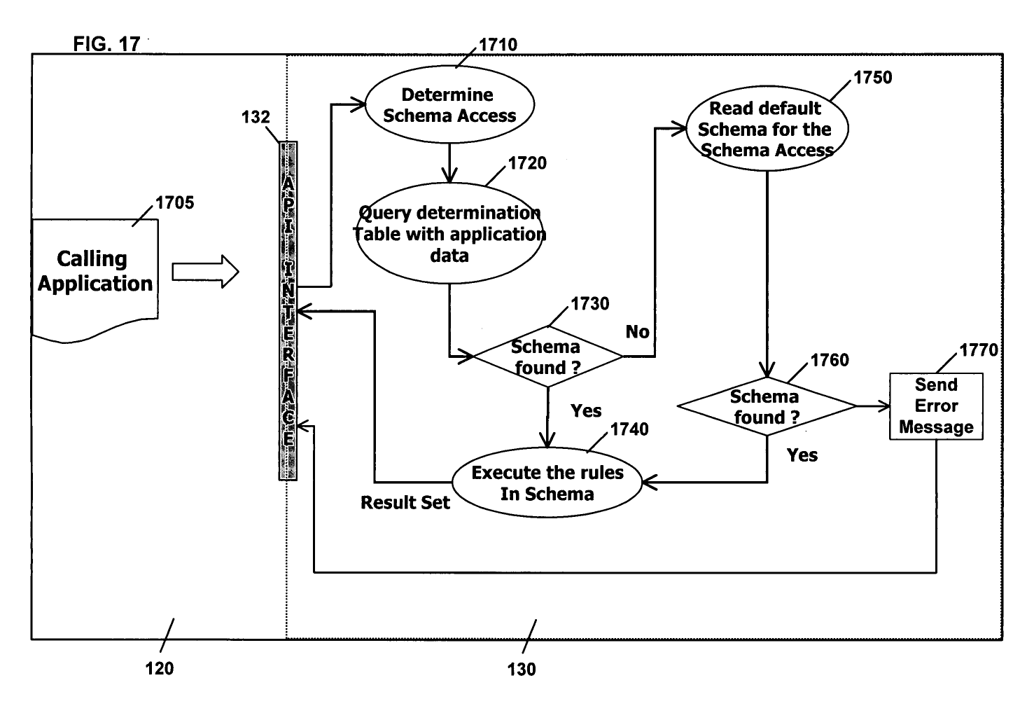

FIG. 17 is a detailed block diagram of the business rule engine that illustrates how a schema is determined in a transaction, in accordance with an embodiment of the present invention. In FIG. 17, a calling application 1705 in business framework 120 may call for the execution of a schema by sending a system name and associated application data to business rule engine 130 via business rule engine API 132. Business rule engine 130 may determine (1710) which schema to access using the supplied system step and query (1720) the determination table with the application data to identify whether the schema is available. Whether the schema is available may be determined (1730) and the rules in the schema may be executed (1740), if the schema is determined (1730) to be available and a result set from the execution of the rules may be sent back to calling application 1705 in business framework 120.

Alternatively, a default schema for the schema access may be read (1750), for example, from the default schema field in rule schema column 1414 that is associated with the schema access. Whether the default schema is available may be determined (1760) and the rules in the default schema may be executed (1740), if the default schema is determined (1760) to be available and a result set from the execution of the rules may be sent back to calling application 1705 in business framework 120. If no default schema is determined (1760) to be available, and error message may be sent (1770) back to calling application 1705.

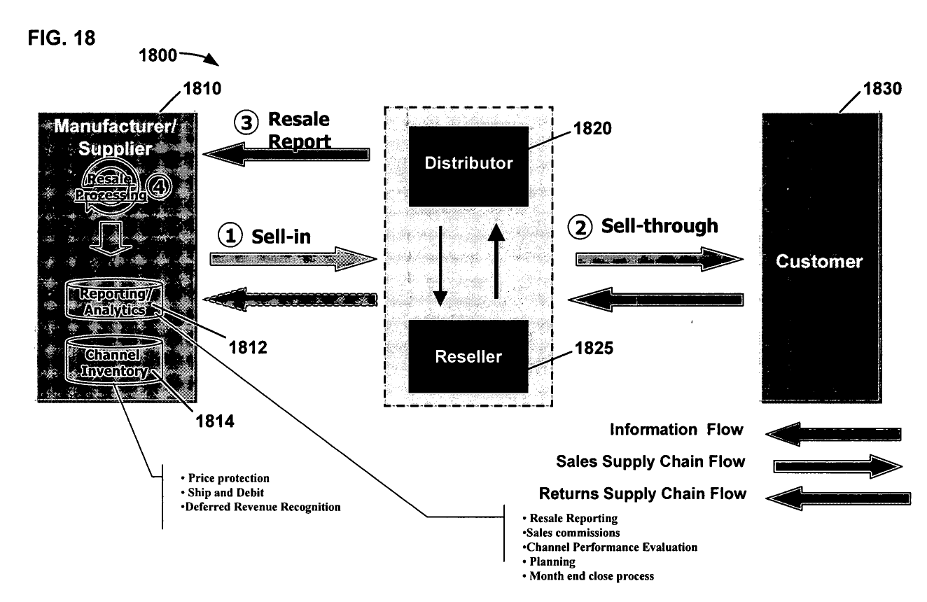

FIG. 18 is a block diagram of a resale tracking application illustrating an overall process in the resale tracking application, in accordance with an embodiment of the present invention. In FIG. 18, a resale tracking system 1800 in which embodiments of the present invention may be implemented. Resale tracking system 1800 may include a manufacturer/supplier system 1810, which may include a reporting/analytics database 1812, a channel inventory database 1814 and a resale processing system 1816 in accordance with an embodiment of the present invention. In communication with a distributor system 1820, which may be in communication with a reseller system 1825. Reseller system 1825 may receive supply chain data flow from one or more customers 1830 purchasing inventory that may be tracked by reseller system 1825. In general, operation of the overall resale tracking system may include a manufacturer/supplier selling (1) products to a distributor who in turn sells (2) the products to a retailer for sale to customers. In addition to the sales to one or more customers 1830, products may be returned to the reseller system 1825 to be resold by the retailer or returned to the manufacturer/supplier.

In FIG. 18, as a result of the sales to the customers, reseller system 1825 may report sales information to distributor system 1820, which may report (3) its own sales information to manufacturer/supplier system 1810 in, for example, a resale report. The sales information reported by distributor system 1820 may or may not include the reseller's sales information. Manufacturer/supplier system 1810 may process (4) the information contained in the resale report and may update reporting/analytics database 1812 and channel inventory database 1814 with results of the processing (4). The results may be used, for example with reporting/analytics database 1812 for resale reporting, sales commission calculations, evaluating sales channel performance, planning for future manufacturing requirements and performing month-end closeout processing. Channel inventory database 1814 may, for example, use the results for price protection calculations, ship and debit processing and deferred revenue recognition.

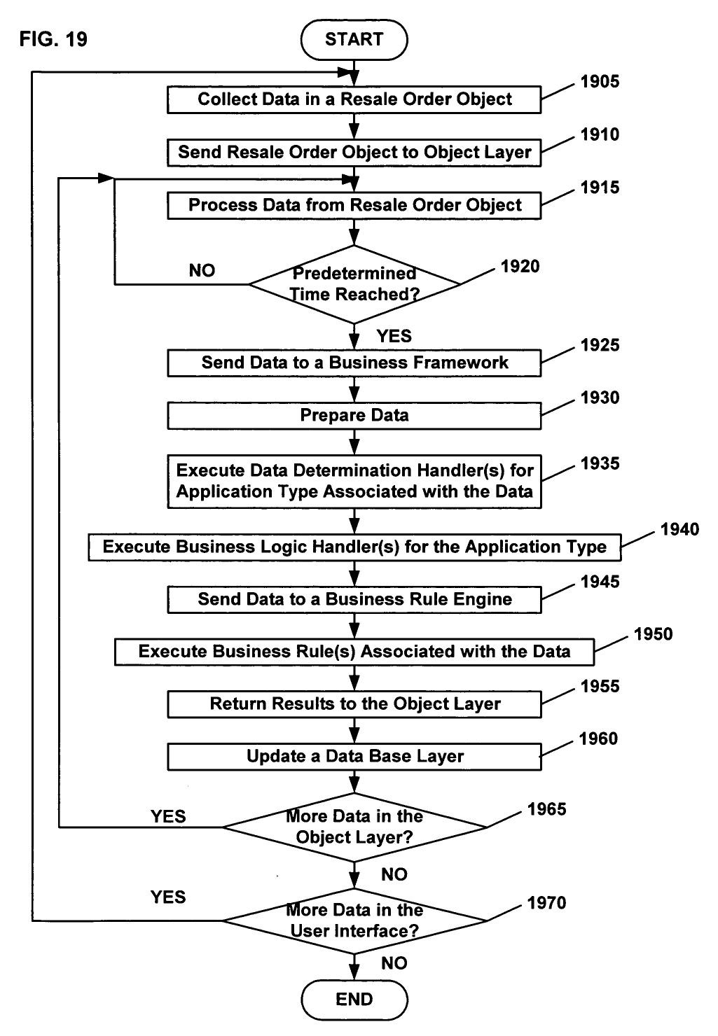

FIG. 19 is a flow diagram of an alternative method of operation in a data model of the resale order framework of FIG. 1, in accordance with an embodiment of the present invention. In FIG. 19, data may be collected (1905) in a resale order object in resale order object framework 100 and may be sent (1910) to resale order object layer 110 in resale order framework 100. Data in the resale order object may be processed (1915) in resale order object layer 110 until a predetermined processing time and/or event may be determined (1920) to have occurred. If the predetermined processing time and/or event has not been determined (1920) to have occurred, the method may loop back to process (1915) additional data in the resale order object and continue processing from that point as previously described.

In FIG. 19, if the predetermined processing time and/or event has been determined (1920) to have occurred, the data may be sent (1925) to business framework 120 via business framework API interface 122 for additional processing. In addition to the data, the application information, the transaction type, the logical event and the processing time may be sent to business framework 120. The data may be prepared (1930) for application of the business logic in business framework 110 by, for example, determining/selecting a DDP associated with the data, and DDHs associated with the application type DDP for the data may be executed (1935) in business framework 120. The method may determine/select a BLP associated with the data and execute (1940) BLHs associated with the application type in business framework 120 and may send (1945) data to business rule engine 130 from business framework 120. Business rules associated with the data may be determined/selected and executed (1950) by business rule engine 130, which may return (1955) results of the execution, for example, a result set, to resale order object layer 110 via the BLH that sent (1945) the data to business rule engine 130. The method may update (1960) a database layer (not shown) from resale order object layer 110. Whether resale order object layer 110 may contain more data may be determined (1965) and, if more data is determined (1965) to be contained in resale order object layer 110, the method may loop back to process (1915) data from another resale order object and continue processing from there as described above. Alternatively, if more data is determined (1965) not to be contained in resale order object layer 110, the method may determine (1970) whether there may be additional data in the user interface and, if additional data is determined (1970) to be in the user interface, the method may loop back and collect (1905) the additional data into the resale order object in resale order object layer 110 and continue processing from there as described above. Alternatively, if additional data is not determined (1970) to be in the user interface, the method may terminate.

Several embodiments of the present invention are specifically illustrated and described herein. However, it will be appreciated that modifications and variations of the present invention are covered by the above teachings and come within the purview of the appended claims without departing from the spirit and intended scope of the invention.

1. A method comprising:
collecting data in a resale order object in an object layer through an interaction layer from a user interface layer;
processing the data in the resale order object to be used in a business framework;
sending the data to the business framework from the object layer at a predetermined time in the processing;
selecting a data determination profile that is associated with the data in the business framework, the data determination profile to define a sequence of the data determination and which data determination handlers need to be executed for a given application, transaction type and logical event;
executing the data determination handlers for the given application, transaction type and logical event;
selecting a business logic profile that is associated with the data in the business framework, the business logic profile to define an execution sequence for one or more business logic handlers associated with the given application, transaction type and logical event;
executing the one or more business logic handlers according to the defined execution sequence;
returning results of the executions of the one or more business logic handlers to the object layer; and
updating a database layer with the results from the object layer.

2. The method of claim 1 wherein processing the data in the resale order object to be used in a business framework comprises:
checking, validating and formatting the data for use by the one or more business logic handlers.

3. The method of claim 1 wherein the user interface is predefined for individual applications.

4. The method of claim 1 further comprising storing the data in an order object that is application independent.

5. The method of claim 4 further comprising associating the order object with event-driven business logic based on the data stored in the order object.

6. The method of claim 4 wherein storing the data comprises:
storing an application associated with the data;
storing a transaction type associated with the data;
storing a logical event associated with the data;
storing a processing time associated with the data.

7. The method of claim 6 wherein sending the data to the business framework comprises:
sending the application, the transaction type, the logical event and the processing time to the business framework.

8. The method of claim 7 further comprising:
reading a customizing for the application and the transaction type.

9. The method of claim 8 wherein executing the data determination handlers comprises:
executing the data determination handlers for the logical event.

10. The method of claim 9 wherein executing the business logic handlers comprises:
executing the business logic handlers for the logical event.

11. The method of claim 10 wherein the determined business logic handlers for the logical event comprises:
sending a system step and application data to a business rule engine for execution.

12. The method of claim 11 further comprising:
determining one or more rule sets for the system step;
executing one or more rules associated with each of the one or more rule sets; and
returning a result set to the business framework.

13. The method of claim 12 wherein returning the results of the executions of the business logic handlers to the object layer comprises:
returning the result set to the object layer.

14. The method of claim 13 wherein updating the database layer comprises:
updating the database layer with the result set from the object layer.

15. The method of claim 1 further comprising:
sending new data to the object layer from the user interface layer.

16. The method of claim 1 further comprising:
sending new data to the business framework from the object layer at another predetermined time in the processing.

17. A computer readable medium having stored thereon a plurality of executable instructions to perform a method comprising:
collecting data in a resale order object in an object layer through an interaction layer from a user interface layer;
processing the data in the resale order object to be used in a business framework;
sending the data to the business framework from the object layer at a predetermined time in the processing;
selecting a data determination profile that is associated with the data in the business framework, the data determination profile to define a sequence of the data determination and which data determination handlers need to be executed for a given application, transaction type and logical event;
executing the data determination handlers for the given application, transaction type and logical event;
selecting a business logic profile that is associated with the data in the business framework, the business logic profile to define an execution sequence for one or more business logic handlers associated with the given application, transaction type and logical event;
executing the one or more business logic handlers according to the defined execution sequence;
returning results of the executions of the one or more business logic handlers to the object layer; and
updating a database layer with the results from the object layer.

18. The computer readable medium of claim 17 wherein processing the data in the resale order object to be used in a business framework comprises:
checking, validating and formatting the data for use by the one or more business logic handlers.

19. The computer readable medium of claim 17 wherein the user interface is predefined for individual applications.

20. The computer readable medium of claim 17 wherein the method further comprises storing the data in an order object that is application independent.

21. The computer readable medium of claim 20 wherein the method further comprises associating the order object with event-driven business logic based on the data stored in the order object.

22. The computer readable medium of claim 20 wherein storing the data comprises:
storing an application associated with the data;
storing a transaction type associated with the data;
storing a logical event associated with the data;
storing a processing time associated with the data.

23. The computer readable medium of claim 22 wherein sending the data to the business framework comprises:
sending the application, the transaction type, the logical event and the processing time to the business framework.

24. The computer readable medium of claim 23 wherein the method further comprises:
reading a customizing for the application and the transaction type.

25. The computer readable medium of claim 24 wherein executing the data determination handlers comprises:
executing the data determination handlers for the logical event.

26. The computer readable medium of claim 25 wherein executing the business logic handlers comprises:
executing the business logic handlers for the logical event.

27. The computer readable medium of claim 26 wherein the determined business logic handlers for the logical event comprises:
sending a system step and application data to a business rule engine for execution.

28. The computer readable medium of claim 27 wherein the method further comprises:
determining one or more rule sets for the system step;
executing one or more rules associated with each of one or more rule sets; and
returning a result set to the business framework.

29. The computer readable medium of claim 28 wherein returning the results of the executions of the business logic handlers to the object layer comprises:
returning the result set to the object layer.

30. The computer readable medium of claim 29 wherein updating the database layer comprises:
updating the database layer with the result set from the object layer.

31. The computer readable medium of claim 17 wherein the method further comprises:
sending new data to the object layer from the user interface layer.

32. The computer readable medium of claim 17 wherein the method further comprises:
sending new data to the business framework from the object layer at another predetermined time in the processing.

33. A resale order infrastructure comprising:
a resale order object layer implementing a multi-layer programming model approach including
a user interface layer to display data,
an object layer implemented as an application programming interface layer to include processing and business logic,
an interaction layer to manage data flow between the user interface layer and the object layer, and
a database layer to control database interactions;
a business infrastructure to execute the business logic associated with data in the resale order object layer; and
a business rule engine connected to the business infrastructure to execute business rules based on the data in the business infrastructure.

34. The resale order infrastructure of claim 33 wherein the resale order object layer is to process incoming data and issue a request to the business infrastructure to execute the business logic associated with the data at a predetermined time during the processing of the data

35. The resale order infrastructure of claim 34 wherein issue a request to the business infrastructure to execute the business logic associated with the data at the predetermined time comprises:
issue a request to the business infrastructure to execute the business logic associated with the data after processing of a single data item.

36. The resale order infrastructure of claim 34 wherein issue a request to the business infrastructure to execute the business logic associated with the data at the predetermined time comprises:
issue a request to the business infrastructure to execute the business logic associated with the data after processing of a document containing a plurality of data items.

37. The resale order infrastructure of claim 34 wherein issue a request to the business infrastructure to execute the business logic associated with the data at the predetermined time comprises:
issue a request to the business infrastructure to execute the business logic associated with the data after processing of a plurality of documents.

38. The resale order infrastructure of claim 34 wherein issue a request to the business infrastructure to execute the business logic associated with the data at the predetermined time comprises:
issue a request to the business infrastructure to execute the business logic associated with the data after saving data from the resale order object layer.

39. The resale order infrastructure of claim 34 wherein the resale order object layer is connected to the business framework by an application programming interface.

40. The resale order infrastructure of claim 39 wherein the application programming interface comprises business and processing logic for the data in the resale order object layer.

41. The resale order infrastructure of claim 34 wherein the business infrastructure is connected to the business rule engine by an application programming interface.

42. The resale order infrastructure of claim 41 wherein the application programming interface comprises business rules for the data in the business infrastructure.

43. The resale order infrastructure of claim 33 wherein the user interface comprises a standard user interface.

44. The resale order infrastructure of claim 33 wherein the user interface comprises a web-enabled user interface.

45. A method comprising:
processing data based on a predetermined and predefined time;
sending an application, transaction type and logical event associated with the data for business logic processing at the predetermined and predefined time;
determining a sequence for data determination and which data determination handlers are associated with the application, the transaction type and the logical event;
executing the determined data determination handlers associated with the data;
determining which business logic handlers are associated with the application, transaction type and logical event;
executing the determined business logic handlers;
returning results of the executions of the business logic handlers; and
updating a database with the results.

46. The method of claim 45 further comprising:
storing the data in an order object that is application independent.

47. The method of claim 46 further comprising associating the order object with event-driven business logic based on the data stored in the order object.

48. The method of claim 46 wherein storing the data comprises:
storing an application associated with the data;
storing a transaction type associated with the data;
storing a logical event associated with the data;
storing a processing time associated with the data.

49. The method of claim 48 wherein sending the application transaction type and logical event comprises:
sending the application, the transaction type, and the logical event to a business infrastructure at the predetermined and predefined processing time.

50. A computer-readable medium having stored therein a data structure for a resale order object, said data structure comprising:
a header extension field delineating the beginning of a resale order object record;
a header administrative record linked to the header extension field and linked to at least one first plurality of fields including
a partner field,
a price field,
a status field,
a documents field, and
a dates field;
at least one item administrative record linked to the header administrative field and linked to at least one second plurality of fields including
a partner field,
a price field,
a status field,
a documents field,
a dates field,
a quantity field, and
a product field; and
an item extension field linked to each at least one item administrative field.

51. The computer-readable medium of claim 50 wherein the number of at least one first plurality of fields linked to the header administrative record is equal to the number of at least one second plurality of fields linked to the item administrative record.

52. The computer-readable medium of claim 50 wherein the partner field, the price field, the status field, the documents field, and the dates field in the header administrative record are shared with the item administrative record.
